(19) United States
(12) Patent Application Publication
(10) Pub. No.: US 2017/0030557 A1
(43) Pub. Date: Feb. 2, 2017

(54) OPTICAL STRUCTURE

(71) Applicant: OPTO TECH CORPORATION, Hsinchu (TW)

(72) Inventors: SHUN-CHIH CHEN, HSINCHU (TW); CHENG-WEI YANG, HSINCHU (TW); CHIA-WEI CHANG, HSINCHU (TW)

(21) Appl. No.: 14/812,009

(22) Filed: Jul. 29, 2015

(51) Int. Cl. F21V 13/04; F21V 7/04; F21V 5/04

(52) U.S. Cl. CPC F21V 13/04; F21V 5/04; F21V 7/04; F21Y 2101/02

(57) ABSTRACT

The present invention relates to an optical structure, which comprises a lens module, a reflective housing, and a light-emitting device. The lens module includes a lens body, which includes a first curved surface and a second curved surface connected symmetrically. The first curved surface extends from the top of the lens body to the front and left sides and reaches the bottom part; the second curved surface extends from the top of the lens body to the front and right sides and reaches the bottom part. The reflective housing includes a housing, which includes a reflective concave surface facing the lens module. In addition, one end of the housing is higher than the lens module. The light-emitting device is disposed between the lens module and the reflective housing and inside the lens module. By using the design of optical structure, light-emitting devices are enabled to project light with high uniformity.

### FIELD OF THE INVENTION

The present invention relates generally to an optical structure, and particularly to an optical structure designed using a reflective housing and a lens module so that a light-emitting device can emit light with high uniformity.

### BACKGROUND OF THE INVENTION

Modern technologies are progressing increasingly. Given the human-based thinking model, lamps are always one of the most important inventions in the history. Until now, there haven been various kinds of lamps, including table lamps, floor lamps, streetlamps, billboard lamps, traffic lights, flashlights, and car lamps. There lamps are applied in various scenarios. Apparently, lamps are a very important invention to us.

As the times advance, the evolution of lamps becomes faster increasingly. Electric lamps are developed gradually from the traditional simplest incandescent bulbs to solar-cell lamps, and finally to LED lamps today. LED lamps requires no warm-up time. They have the advantages of fast response time, small size, saving power, low pollution, high mass productivity, and high reliability. Besides, according to the requirements in applications, they can be manufactured as miniature or matrix-type devices. Hence, LEDs are applied extensively to various lighting applications and their market share is growing. They are applied to different products such as LED car lamps, LED streetlamps, LED table lamps, and various small lamps for displaying.

Currently, there are many products making use of LEDs. In particular, many stores have rows of billboard lamps or spotlight for large billboards at night. According to the prior art, the T-bar billboards along highways adopt projective lights for lighting the billboards at night and thus showing the advertisements clearly. Nonetheless, to light a large-area billboard, multiple sets of lamps are required. In addition, each set of lamps needs to include a plurality of LED chips to light the corresponding billboards. It requires massive electrical energy and expense by using the above method, making the charge for lighting per night daunting. Considering the drawbacks of the billboards according to the prior art, how to reduce the cost while maintaining the same efficacy of billboards has become the problem to be solved and the target to be achieved.

Accordingly, the present invention provides an optical structure for lamps. By using the design of optical structure for lens module and reflective housing, light-emitting devices are enabled to project light with high uniformity and the required quantity of lamps can be reduced. Furthermore, the required quantity of light-emitting devices in each lamp can be reduced. Thereby, better light-emitting efficiency can be achieved by using fewer light-emitting devices.

### SUMMARY

An objective of the present invention is to provide an optical structure. By using the design of optical structure, light-emitting devices are enabled to project light with high uniformity.

In order to achieve the above objective and efficacy, the present invention provides an optical structure, which comprises a lens module, a reflective housing, and a light-emitting device. The lens module includes a lens body, which includes a first curved surface and a second curved surface connected symmetrically. The first curved surface extends from the top of the lens body to the front and left sides and reaches the bottom part; the second curved surface extends from the top of the lens body to the front and right sides and reaches the bottom part. The reflective housing includes a housing, which includes a reflective concave surface facing the lens module. In addition, one end of the housing is higher than the lens module. The light-emitting device is disposed between the lens module and the reflective housing and inside the lens module.

### BRIEF DESCRIPTION OF THE DRAWINGS

FIG. 1A shows a schematic diagram of the optical structure according to the first embodiment of the present invention;

FIG. 1B shows an exploded diagram of the optical structure according to the first embodiment of the present invention;

FIG. 1C shows another exploded diagram of the optical structure according to the first embodiment of the present invention;

FIG. 1D shows an optical path diagram of the optical structure according to the first embodiment of the present invention;

FIG. 1E shows another optical path diagram of the optical structure according to the first embodiment of the present invention;

FIG. 2A shows a schematic diagram of the optical structure according to the second embodiment of the present invention;

FIG. 2B shows another schematic diagram of the fixing member according to the second embodiment of the present invention; and

FIG. 2C shows a usage status diagram of the fixing member according to the second embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

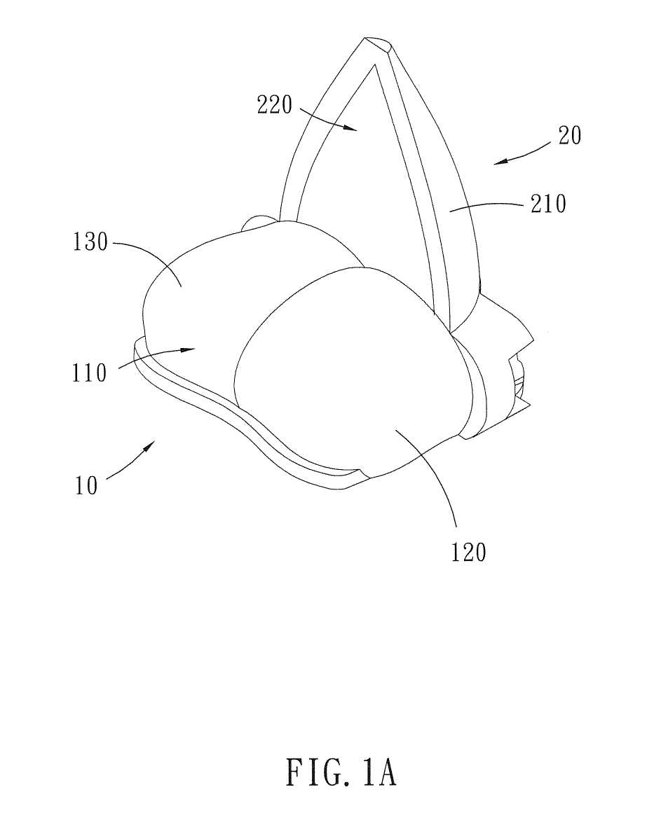

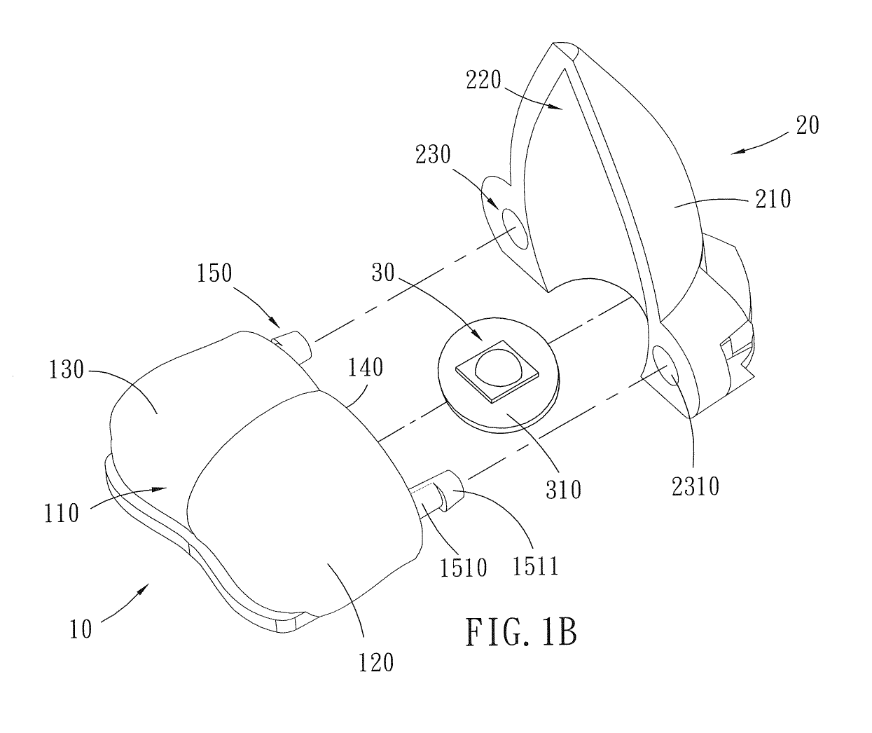

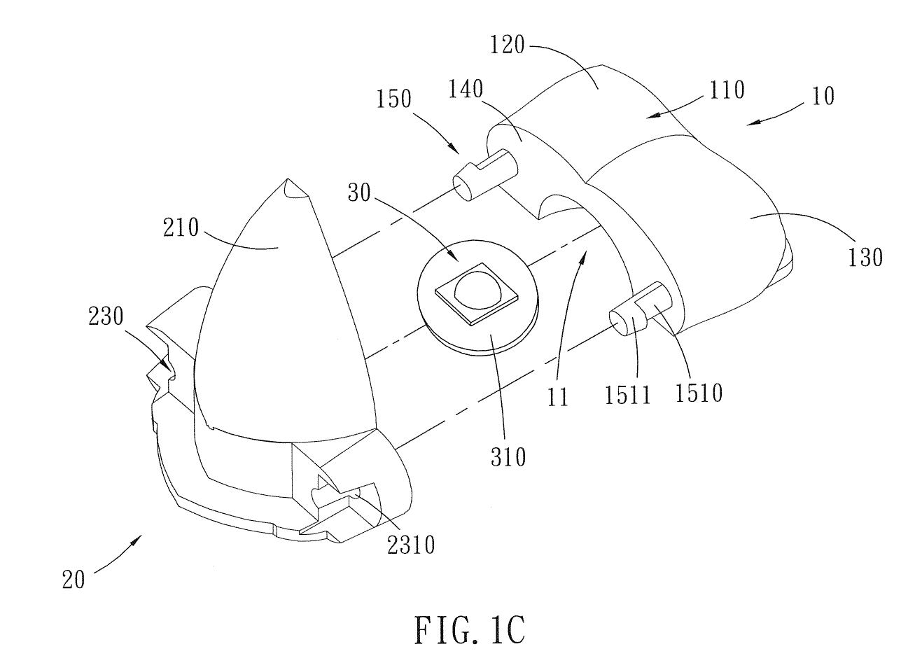

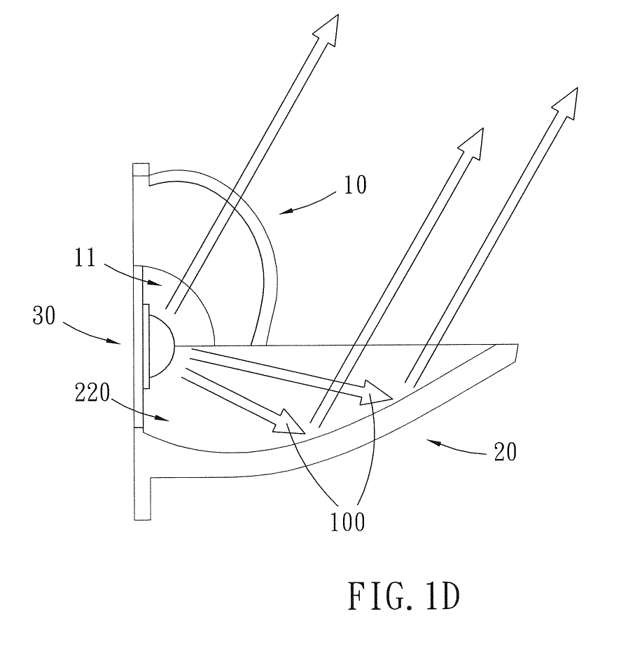

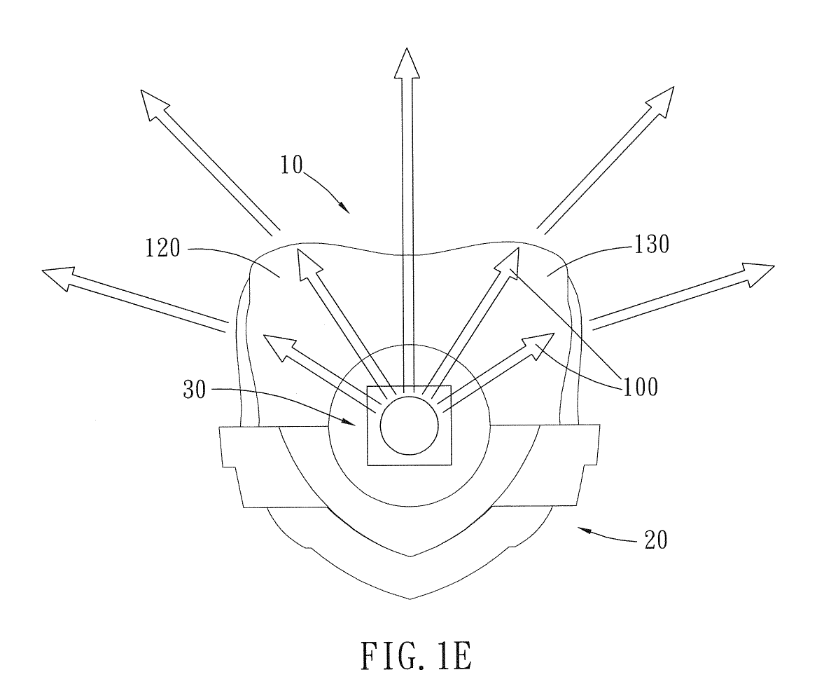

Please refer to FIGS. 1A to 1E, which show a schematic diagram, exploded diagrams, and optical path diagrams of the optical structure according to a first embodiment of the present invention. As shown in the figures, the present invention relates to an optical structure, which comprises at least a lens module 10, a reflective housing 20, and a light-emitting device 30. The lens module 10 includes a lens body 110, which includes a first curved surface 120 and a second curved surface 130 connected symmetrically. The first curved surface 120 extends from the top of the lens body 110 to the front and left sides and reaches the bottom part; the second curved surface 130 extends from the top of the lens body 110 to the front and right sides and reaches the bottom part. The reflective housing is disposed on one side of the lens module 10 and includes a housing 210. The housing 210 includes a reflective concave surface 220 facing the lens module 10. In addition, one end of the housing 210 is higher than the lens module 10. The light-emitting device 30 is disposed between the lens module 10 and the reflective housing 20 and inside the lens module 10.

The lens module 10 is a continuous curved surface formed by connecting the first and second curved surfaces 120, 130, which are just the light-emitting surfaces of the light-emitting device 30. Besides, the reflective housing 20 is a pointed arc structure. The reflective housing 20 according to the present embodiment is disposed on one side of the lens module 10. The lens module 10 includes a first fixing structure 150 on a contact surface 140 opposing the reflective housing 20. A second fixing structure 230 is disposed on the reflective housing opposing the first fixing structure 150. The first fixing structure 150 combines with the second fixing structure 230. Moreover, the first fixing structure 150 includes one or more fixing pillar 1510; the second fixing structure 230 includes one or more fixing hole 2310. The one or more fixing pillar 1510 passes through the one or more fixing hole 2310. In addition, the one or more fixing pillar 1510 includes a fixing hook 1511 at the end thereof. The fixing hook 1511 hooks and thus fixed in the one or more fixing hole 2310.

Besides, the light-emitting device 30 is disposed on a base 310. The base 310 is disposed inside the reflective concave surface 220 of the reflective housing 20 and inside a concave 11. A part of the light-emitting device 30 is disposed in the concave 11; the other part thereof is disposed inside the reflective concave surface 220. The light-emitting device 30 is disposed in the package structure of LED using a lens housing.

Please refer again to FIGS. 1D and 1E, which show optical path diagrams according to the embodiment of the present invention. The light-emitting device 30 emits light 100. The illuminating range of the light 100 can be described in the vertical and horizontal directions. The vertical illuminating range of the light 100 is influenced by the reflective housing 200. A portion of the light 100 illuminates upwards via the lens module 10; the other part thereof illuminates downwards. After reflected by the reflective concave surface 220 of the reflective housing 20, the downward light 100 is concentrated and then illuminates upwards.

The reflective housing 20 is a pointed arc housing corresponding to the illuminating angle of the light 100 and thus controlling the reflection of the light 100 from the reflective housing 20. Then the reflected light 100 becomes a uniform light source to a certain range. In addition, the reflective concave surface 220 covers completely the light 100 in the downward direction. In other words, the reflective concave surface 220 can reflect the light 100 from the light-emitting device 30 in the downward direction and concentrate the light 100 to illuminate upwards without consuming the light source. Moreover, the light 100 of the light-emitting device 30 illuminate the reflective concave surface 220. The curvature of the reflective concave surface 220 enables the directions of the optical paths of the reflected light 100 to be upward and forward. Thereby, optical energy loss of the light 100 after secondary reflection can be avoided and most of the light 100 by the light-emitting device 30 can be utilized efficiently.

Furthermore, the horizontal illuminating range of the light 100 is influenced by the lens module 10. A part of the light 100 by the light-emitting device 30 passes through the connected surface of the first and second curved surfaces 120, 130 and illuminates upwards directly. The other part of the light 100 passes through the first and second curved surfaces 120, 130. The light 100 is influenced by the curved surfaces and refracted to both sides, thus broadening the illuminating ranges of the light 100 on both sides.

According to the present embodiment, the lens module 10 is used for broadening the illuminating width of the light 100. The reflective housing 20 is used for concentrating the energy of the light 100 to illuminate upwards. Thereby, the light-emitting device 30 can achieve the preferred light-emitting effect and the projected light is highly uniform.

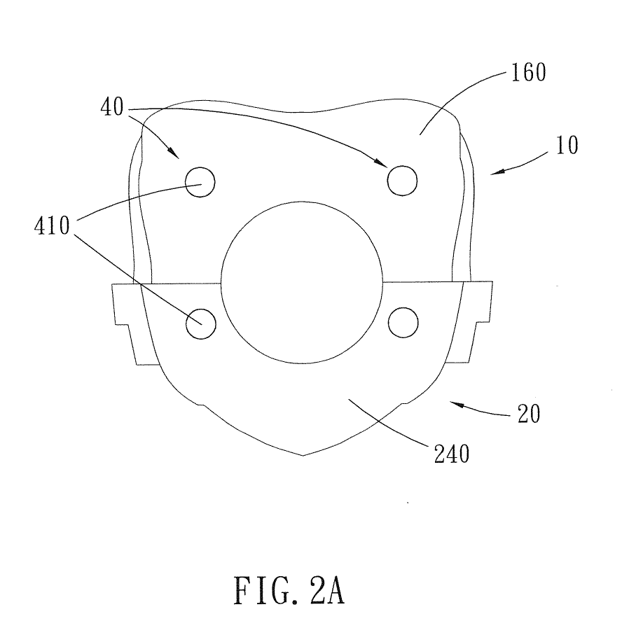

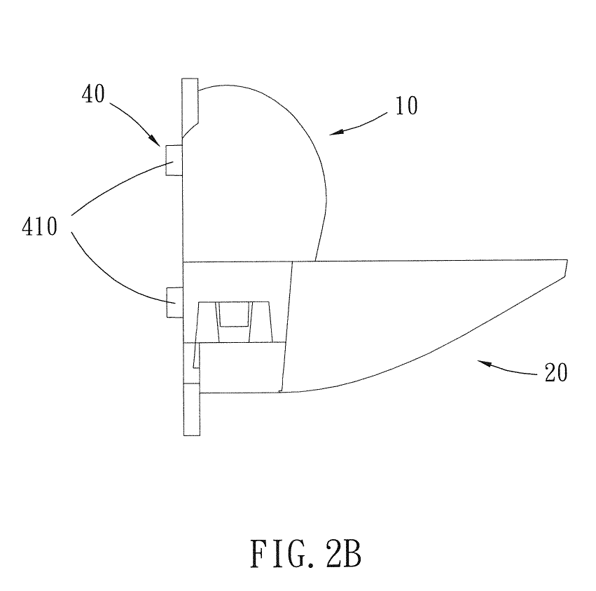

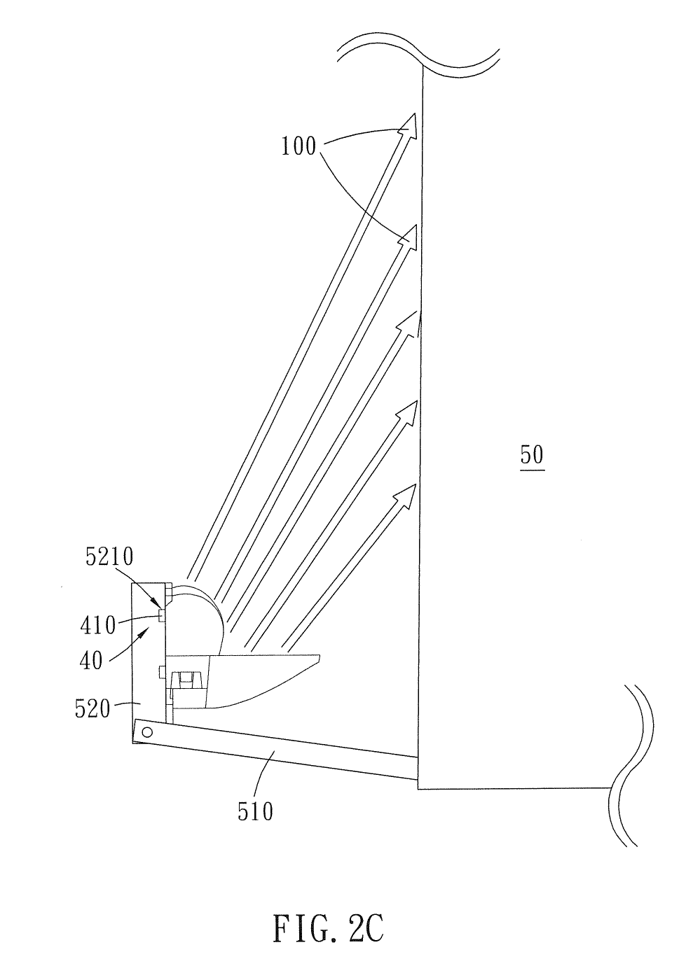

Please refer to FIGS. 2A to 2C, which show schematic diagrams and a usage status diagram of the optical structure according to the second embodiment of the present invention. As shown in the figure, according to the present embodiment, a fixing member 40 is further disposed. The fixing member 40 is disposed on a bottom surface 160 of the lens module 10 or a bottom housing surface 240 of the reflective housing 20 adjacent to the bottom surface 160. According to the present embodiment, the lamp is applied to a billboard 50. The billboard 50 includes a supporting arm 510 and a supporting base 520. One end of the supporting arm is connected to one side of the billboard 50. The other end of the supporting arm 510 is disposed at the supporting base 520. The fixing member 40 is disposed at the supporting base 520. The fixing member 40 includes one or more fixing bump 410. One or more fixing trench 5210 is disposed on the supporting base 520 corresponding to the fixing bump 410. The one or more fixing bump 410 is disposed in the one or more fixing trench 5210. Furthermore, the reflective concave surface 220 of the reflective housing 20 faces up, so that the light 100 by the light-emitting device 30 is concentrated and illuminates upwards to the billboard 50.

To sum up, the present invention relates to an optical structure. The light-emitting device emits the light. The light is reflected by the reflective housing in the vertical direction and thus enabling the light to be concentrated and illuminate upwards. The light is refracted by the lens module in the horizontal direction and thus illuminating to both sides. It is thereby possible to project light with high uniformity by using small light-emitting devices.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An optical structure, comprising:
a lens module, having a lens body, including a first curved surface and a second curved surface connected symmetrically, said first curved surface extending from the top of said lens body to the front and left sides and reaching the bottom part, and said second curved surface extending from the top of said lens body to the front and right sides and reaching the bottom part;
a reflective housing, disposed on one side of said lens module, including a housing, said housing including a reflective concave surface facing said lens module, and one end of said housing higher than said lens module; and
a light-emitting device, disposed between said lens module and said reflective housing and inside said lens module.

2. The optical structure of claim 1, wherein said light-emitting device emits light, and said reflective housing is a pointed arc housing corresponding to the illuminating angle of said light emitted by said light-emitting device.

3. The optical structure of claim 1, wherein said light-emitting device emits light, and said reflective concave surface covers completely said light emitted by said light-emitting device in the downward direction and reflects said light to illuminate upwards completely.

4. The optical structure of claim 1, wherein said light-emitting device emits light; said light passes through said first curved surface and said second curved surface; and said light is influenced by said first curved surface and said second curved surface and refracted to both sides.

5. The optical structure of claim 1, wherein said light-emitting device emits light; said light illuminate on said reflective concave surface; and the curvature of said reflective concave surface enables the directions of the optical paths of said reflected light to be upward and forward.

6. The optical structure of claim 1, wherein said lens module includes a first fixing structure on a contact surface opposing said reflective housing; a second fixing structure is disposed on said reflective housing opposing said first fixing structure; and said first fixing structure combines with said second fixing structure.

7. The optical structure of claim 6, wherein said first fixing structure includes one or more fixing pillar; said second fixing structure includes one or more fixing hole; and said one or more fixing pillar passes through said one or more fixing hole.

8. The optical structure of claim 7, wherein said one or more fixing pillar includes a fixing hook at the end thereof, and said fixing hook is fixed in said one or more fixing hole.

9. The optical structure of claim 1, and further comprising a fixing member disposed on a bottom surface of said lens module or a bottom housing surface of said reflective housing.
